(19) United States
(12) Patent Application Publication
(10) Pub. No.: US 2025/0199824 A1
(43) Pub. Date: Jun. 19, 2025

(54) PSEUDO VISUAL ELEMENT UI RENDERING

(71) Applicant: SAP SE, Walldorf (DE)

(72) Inventors: Ashish Anand, Bengaluru (IN); Vinod S. Nair, Bengaluru (IN); Arijit Sarkar, Bengaluru (IN); Mounika V, Bengaluru (IN); Sanchit Shrivastava, Bengaluru (IN); Santhosh ., Bengaluru (IN); Prasanth Karukkuvel, Bengaluru (IN); Ashwin Kumar Bolar, Bengaluru (IN); Vella Nageshwar Rao, Bengaluru (IN)

(21) Appl. No.: 18/541,242

(22) Filed: Dec. 15, 2023

(51) Int. Cl. G06F 9/451; G06T 11/20; H04L 41/22

(52) U.S. Cl. CPC G06F 9/451; G06T 11/206; H04L 41/22

(57) ABSTRACT

This disclosure describes systems, software, and computer implemented methods for generating user interfaces (UI's) to be rendered at a low computational cost at a client device. The client device can execute a relatively low resource requirement application, such as a web browser, or lightweight portal application. To enable this lightweight application to render a user interface with a large number of visual elements, or otherwise to reduce the rendering time required to render such a UI, pseudo visual elements or combination element can be generated. Pseudo visual elements can combine multiple visual elements in a UI into a single element that reduces the number of elements displayed while retaining much of the information provided.

### BACKGROUND

Modern systems often rely on a browser, or relatively lightweight local application to render and display complex information and user interfaces (UI's) provided by backend servers. This technique is often used in enterprise software systems, where a software provider hosts an enterprise service that enables business intelligence, enterprise communication, inventory management, marketing tools, online payments, enterprise resource planning, and other features to be accessed. These systems often utilize large databases and high compute cost applications, and can be accessed from a variety of relatively low compute power systems such as personal computers, tablets, cell phones, etc.

### SUMMARY

The present disclosure involves systems, software, and computer implemented methods for improved UI rendering. These can include receiving a request to provide a user interface that includes a plurality of visual elements, analyzing the plurality of visual elements and identifying a subset of visual elements that are combinable. Based on the analysis, a pseudo visual element can be generated that represents two or more particular visual elements of the subset of visual elements, where each particular visual element is graphically represented in the pseudo visual element. The user interface can be updated by replacing the two or more particular visual elements with the pseudo visual element and information can be sent to a client device to cause the client device to render the updated user interface at a display associated with the client device.

Implementations can optionally include one or more of the following features.

In some instances, the subset of visual elements that are combinable includes visual elements that are at least one of: adjacent to each other; or within a predetermined distance from each other.

In some instances, the subset of visual elements that are combinable includes visual elements that are associated with overlapping timelines.

In some instances, the pseudo visual element includes multiple colors, and the multiple colors graphically represent each particular visual element.

In some instances, a selection of the pseudo visual element is received in the updated user interface and in response, information is sent to the client device to cause the two or more replaced visual elements to be rendered in the updated user interface. In some instances, the pseudo visual element is then removed form the user interface. In some instances, the pseudo visual element is rendered next to the two or more replaced visual elements.

In some instances, the user interface is a Gantt chart, and the visual elements are tasks to be rendered within a timeline of the Gantt chart.

In some instances, the user interface is a network diagram that includes nodes and edges, and the visual elements are nodes within the network diagram.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings. In some instances, like reference numbers may indicate similar elements.

FIG. 1 is a simplified block diagram of an example system for rendering UI's remotely.

FIGS. 2A-2C illustrate an example Gantt chart UI that uses pseudo visual elements.

FIGS. 3A-3C illustrate an example network diagram UI that uses pseudo visual elements.

FIGS. 4A and 4B illustrate an example timeline UI that uses pseudo visual elements.

FIG. 5 is a flowchart describing an example process for reducing the number of visual elements in a user interface.

FIG. 6 is a flowchart describing an example process for generating a simplified user interface.

FIG. 7 is a block diagram illustrating an example of a computer-implemented system.

### DETAILED DESCRIPTION

This disclosure describes methods, software, and systems for generating user interfaces (UIs) to be rendered at a low computational cost at a client device. The client device can execute a relatively low resource requirement application, such as a web browser or lightweight portal application. To enable this lightweight application to render a user interface with a large number of visual elements, or otherwise to reduce the rendering time required to render such a UI, pseudo visual elements or combination elements can be generated. Pseudo visual elements can combine multiple visual elements in a UI into a single element that reduces the number of elements displayed while retaining much of the information provided.

In general, the disclosed system is advantageous in that much of the processing can be performed at a backend system with access to more computing resources. Additionally, the disclosed pseudo visual elements can be flexibly applied as resources and view requirements change. Another advantage is that total network traffic can be reduced, as the entirety of the UI need not necessarily be transmitted to the client device.

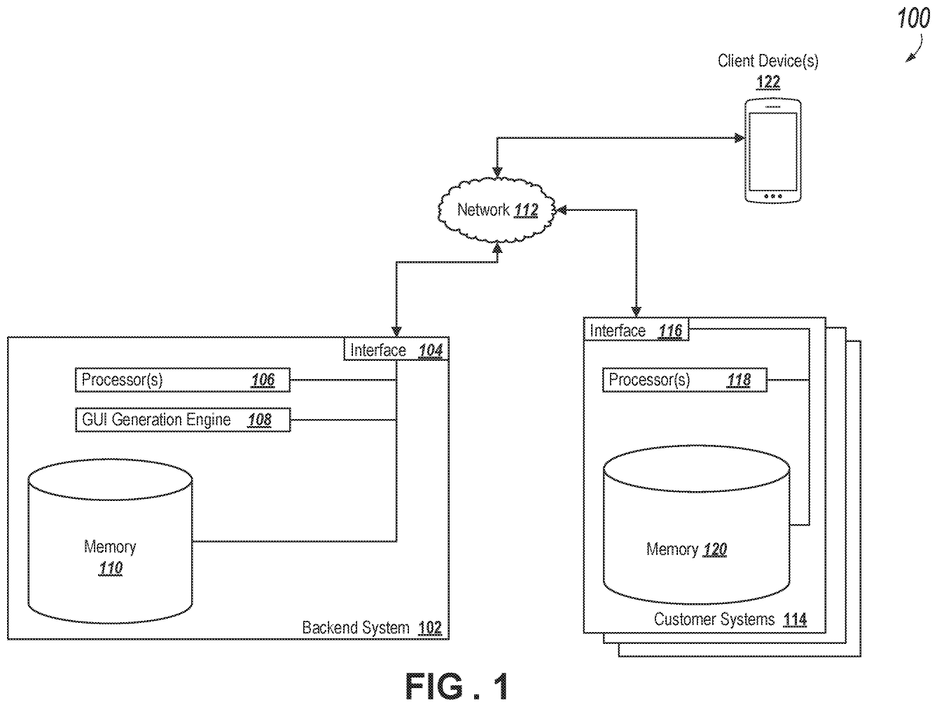

Turning to the illustrated example implementations, FIG. 1 is a simplified block diagram of an example system 100 for rendering UIs remotely. The system includes a backend system 102, customer systems 114, a network 112, and one or more client devices 122. At a high level, a user interacts with backend system 102 via client device 122, communicating over the network 112. The client device 122 can request a user interface from the backend system 102, which can generate the interface, which can be populated with data from backend system 102, one or more customer systems 114, or a combination thereof. The generated interface can then be simplified or reduced via the generation of pseudo visual elements, and sent to the client device 122 for rendering.

Client devices 122 can include mobile computing devices such as smartphones, laptops, tablets, or other devices, or other computing devices such as a desktop computer, kiosk, or other suitable device. In general, the client device 122 executes software for communicating with and rendering information received from the backend system 102. This software can be, for example, a web browser, or a portal application, among other things.

Network 112 facilitates wireless or wireline communications between the components of the system 100 (e.g., between the backend system 102, the client device(s) 122, and the customer systems 114), as well as with any other local or remote computers, such as additional mobile devices, clients, servers, or other devices communicably coupled to network 112, including those not illustrated in FIG. 1. In the illustrated environment, the network 112 is depicted as a single network, but can comprise more than one network without departing from the scope of this disclosure, so long as at least a portion of the network 112 can facilitate communications between senders and recipients. In some instances, one or more of the illustrated components can be included within or deployed to network 112 or a portion thereof as one or more cloud-based services or operations. The network 112 can be all or a portion of an enterprise or secured network, while in another instance, at least a portion of the network 112 can represent a connection to the Internet. In some instances, a portion of the network 112 can be a virtual private network (VPN). Further, all or a portion of the network 112 can comprise either a wireline or wireless link. Example wireless links can include 802.11a/b/g/n/ac, 802.20, WiMax, LTE, and/or any other appropriate wireless link. In other words, the network 134 encompasses any internal or external network, networks, sub-network, or combination thereof operable to facilitate communications between various computing components inside and outside the illustrated system 100. The network 112 can communicate, for example, Internet Protocol (IP) packets, Frame Relay frames, Asynchronous Transfer Mode (ATM) cells, voice, video, data, and other suitable information between network addresses. The network 112 can also include one or more local area networks (LANs), radio access networks (RANs), metropolitan area networks (MANs), wide area networks (WANs), all or a portion of the Internet, and/or any other communication system or systems at one or more locations.

Backend system 102 includes one or more processors 106, a GUI generation engine 108, an interface 104, and a memory 110. The backend system receives requests from client devices 122 and generates responses for consumption by the client device 122. In generating the response, the backend system 102 can query or access data from one or more external systems such as customer systems 114 or other remote databases.

Although illustrated as a single processor 106 in FIG. 1, multiple processors can be used according to particular needs, desires, or particular implementations of the system 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the asset management system 102. Specifically, the processor 106 executes the algorithms and operations described in the illustrated figures, as well as the various software modules and functionality, including the functionality for sending communications to and receiving transmissions from client devices 122, customer systems 114, as well as to other devices and systems. Each processor 106 can have a single or multiple core, with each core available to host and execute an individual processing thread. Further, the number of, types of, and particular processors 106 used to execute the operations described herein can be dynamically determined based on a number of requests, interactions, and operations associated with the backend system 102.

Interface 104 is used by the backend system 102 for communicating with other systems in a distributed environment-including within the system 100—connected to the network 112, e.g., client 122, and other systems communicably coupled to the illustrated backend system 102 and/or network 112. Generally, the interface 104 comprises logic encoded in software and/or hardware in a suitable combination and operable to communicate with the network 112 and other components. More specifically, the interface 104 can comprise software supporting one or more communication protocols associated with communications such that the network 112 and/or interface's 104 hardware is operable to communicate physical signals within and outside of the illustrated system 100. Still further, the interface 104 can allow the backend system 102 to communicate with the client 122, and customer systems 114, and/or other portions illustrated within the system 100 to perform the operations described herein.

Memory 110 of the backend system 102 can represent a single memory or multiple memories. The memory 110 can include any memory or database module and can take the form of volatile or non-volatile memory including, without limitation, magnetic media, optical media, random access memory (RAM), read-only memory (ROM), removable media, or any other suitable local or remote memory component. The memory 110 can store various objects or data, including digital asset data, public keys, user and/or account information, administrative settings, password information, caches, applications, backup data, repositories storing business and/or dynamic information, and any other appropriate information associated with the backend system 102, including any parameters, variables, algorithms, instructions, rules, constraints, or references thereto. Additionally, the memory 110 can store any other appropriate data, such as VPN applications, firmware logs and policies, firewall policies, a security or access log, print or other reporting files, as well as others. While illustrated within the backend system 102, memory 110 or any portion thereof, including some or all of the particular illustrated components, can be located remote from the backend system 102 in some instances, including as a cloud application or repository or as a separate cloud application or repository when the backend system 102 itself is a cloud-based system. In some instances, some or all of memory 110 can be located in, associated with, or available through one or more other systems of the associated enterprise software platform. In those examples, the data stored in memory 110 can be accessible, for example, via one of the described applications or systems.

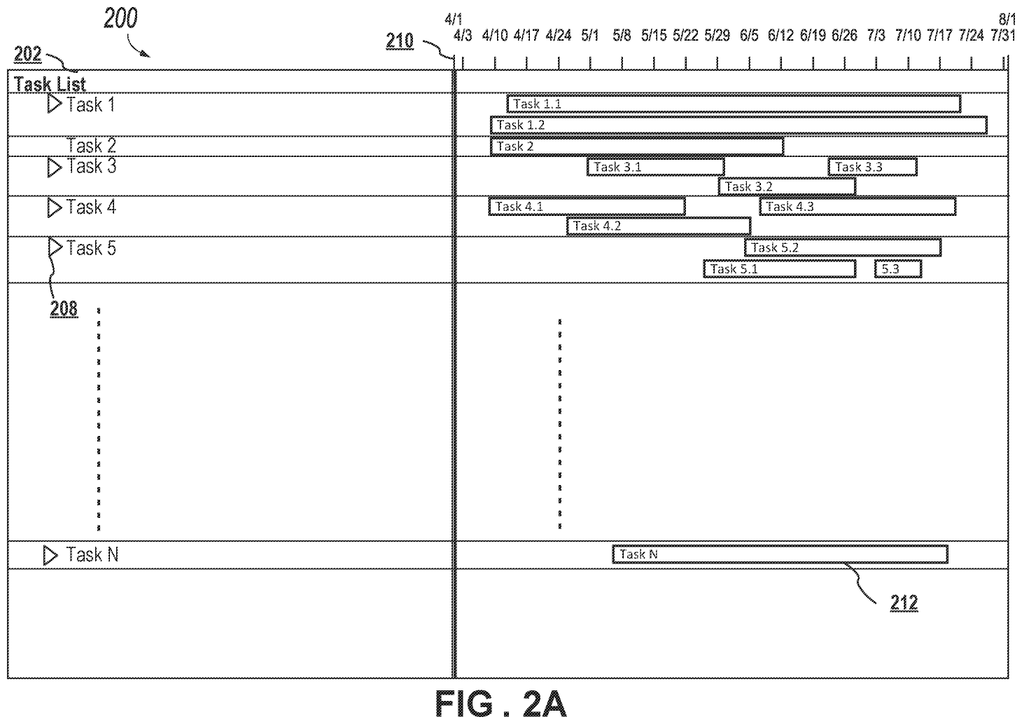

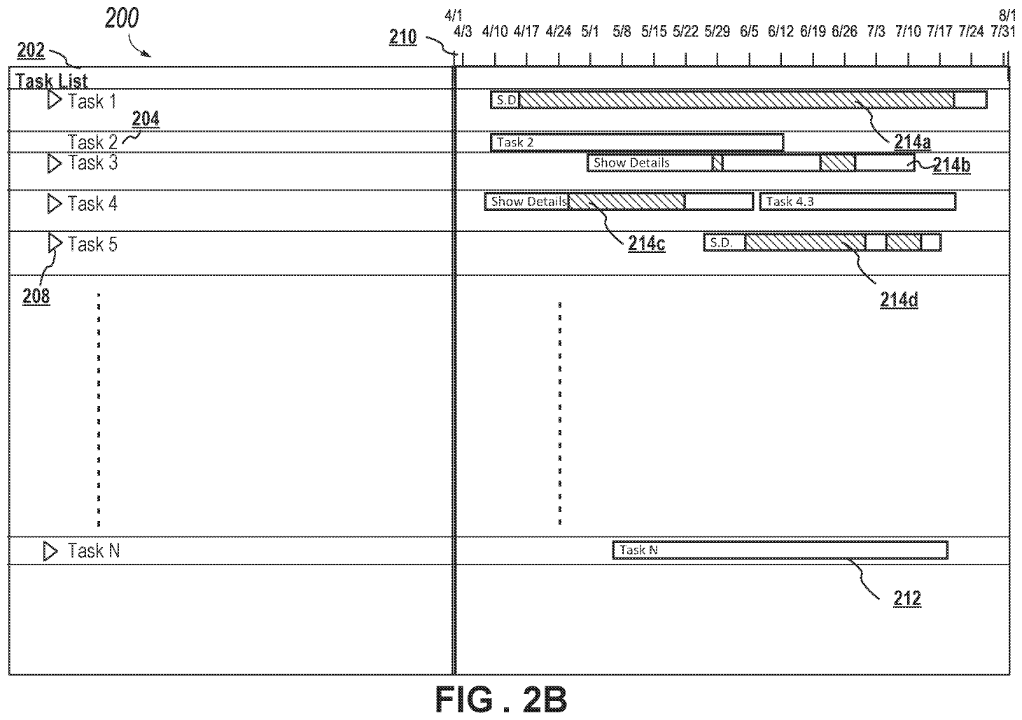

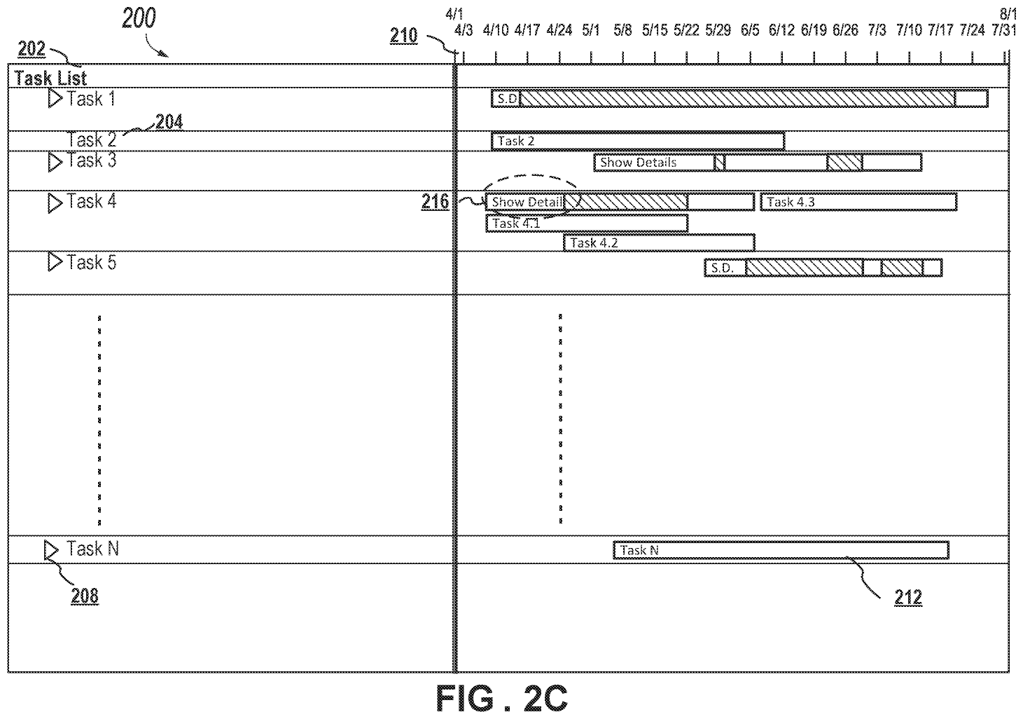

GUI generation engine 108 can be a software application or set of applications designed to generate graphical user interfaces (GUIs) or UIs based on a query or request from the client device 122 or customer system 114. The GUI generation engine 108 creates the requested GUI, and then compresses or abstracts the requested GUI to a format suitable for consumption by the client device 122 or customer systems 114. This abstraction or compression can include generation of pseudo visual elements which replace two or more visual elements within the UI, thereby reducing the overall number of visual elements within the UI. Pseudo visual elements are discussed in more detail below with respect to FIGS. 2-6. The GUI generation engine 108 can then send the requested UI to the client device 122 or customer systems 114 as appropriate. In some implementations, the GUI generation engine 108 generates the UI by extracting data from memory 110. In some implementations, additional data is requested, polled, or queried from customer systems 114, which can send data from their associated memory 120.

The customer systems 114 are computing systems managed or owned by a customer or third party. In some implementations, the customer systems 114 are hosted by a third party (e.g., Amazon Web Services) and operated by the customer. They can include one or more processors 118, which can be similar to processor 106 as described above. Customer systems 114 also include an interface 116 and a memory 120 that can store data such as account information, user preferences, scheduling information, or other data managed by the customer. Memory 120 can be similar to, or different from memory 110 as described above.

FIGS. 2A-2C illustrate an example Gantt chart UI 200 that uses pseudo visual elements. The UI 200 includes a task list 202, with a number of tasks 204. The task list can include interactive UI elements, such as arrows 208, which indicate hidden subtasks which can be expanded or are already expanded. When the arrow 208 is pointed to the right, it is an indication that there are subtasks nested under that task. When an arrow is pointed down (not shown), it is an indication that the subtasks are expanded in the below list.

The right portion of the UI 200 shows the timeline 210, which can present dates, times, years, or other parameters by which the tasks are organized (e.g., location, cost, etc.). The timeline 210 defines a horizontal axis upon which task elements 212 are rendered. Each task 204 and can have one or more task elements 212 which include a label showing name, team ownership, or other relevant information.

While the illustrated Gantt chart in UI 200 only includes a few tasks and task elements 212 for simplicity, UIs with hundreds, thousands, or even more task elements 212 are possible. While the backend system (e.g., backend system 102 of FIG. 1) may have the computational power to generate and render such a UI 200, a more limited client device 122 attempting to display the UI 200 may cause performance issues, and, to optimize presentation and performance, a reduced number of task elements 212 would be advantageous.

In order to reduce the number of visual elements, pseudo visual elements can be generated to replace at least some of the task elements 212 in UI 200. FIG. 2B illustrates several pseudo visual elements 214a-d which replace some task elements 212 that were previously present in FIG. 2A. For example, tasks 3.1, 3.2 and 3.3 have been combined into a single pseudo visual element 214c. The pseudo visual elements 214a-d can include a different color where the tasks overlap (e.g., between 4/24 and 5/22 on the pseudo visual element 214c for tasks 4.1 and 4.2). Additionally, the label information can be changed to indicate multiple tasks are represented by a single pseudo visual element. For example, the label for the pseudo visual element 214c combining tasks 4.1 and 4.2 now says “show details.” In some implementations, the label can be abbreviated (e.g.,

S.D.”) or shortened (e.g., “details”).

The pseudo visual elements 214a-d can be selected based on different criteria to maximize the reduction of visual elements while maintaining a similar overall UI 200 and minimizing the amount of information lost. In the illustrated Gantt chart implementations, any two overlapping and adjacent tasks can be selected to be combined into a pseudo visual element. In some implementations, any overlap that would result in three or more simultaneous tasks is not selected, and the pseudo visual elements 214a-d are limited to two overlapping tasks. In some implementations, other parameters are used to determine which elements to combine. For example, elements can be combined based on team ownership, duration, proximity, or other relevant and related factors.

In FIG. 2B, task 2 is selected or focused on, thus pseudo visual elements have not been generated for task 2, as the user has indicated an interest in, and has interacted with, the detailed view of task 2.

FIG. 2C is the resulting UI 200 where the user selects the pseudo visual element 214c, clicking on “show detail” (216 in FIG. 2C) for tasks 4.1 and 4.2. The associated pseudo visual element remains, but tasks 4.1 and 4.2 are rendered underneath the pseudo visual element, showing their full labels and details. In response to the selection (of 216), only the two additional visual elements need to be rendered, which maintains a reduced workload for the client device as compared to solutions that abstract based on zoom level. Restated, the other non-selected elements remain as pseudo visual elements, where appropriate, such that only the selected portions are expanded with additional detail into their respective elements.

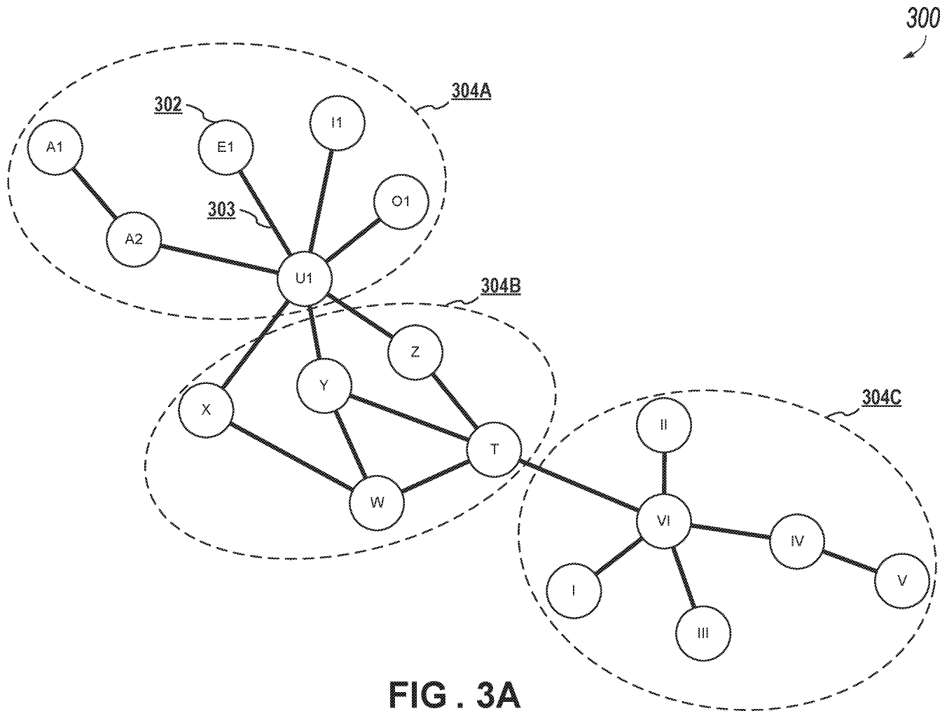

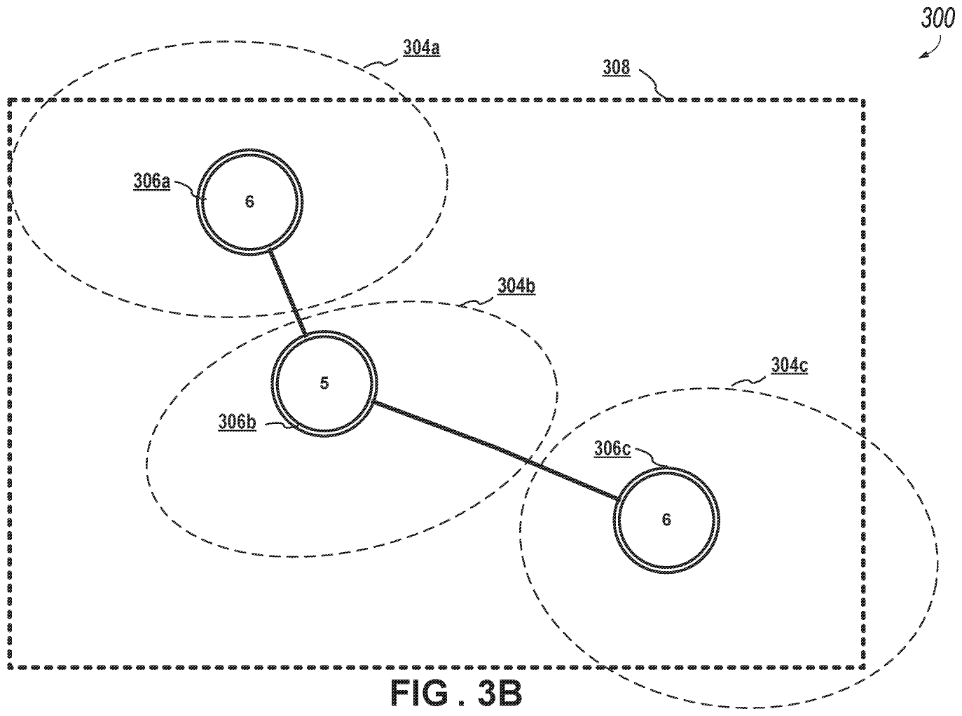

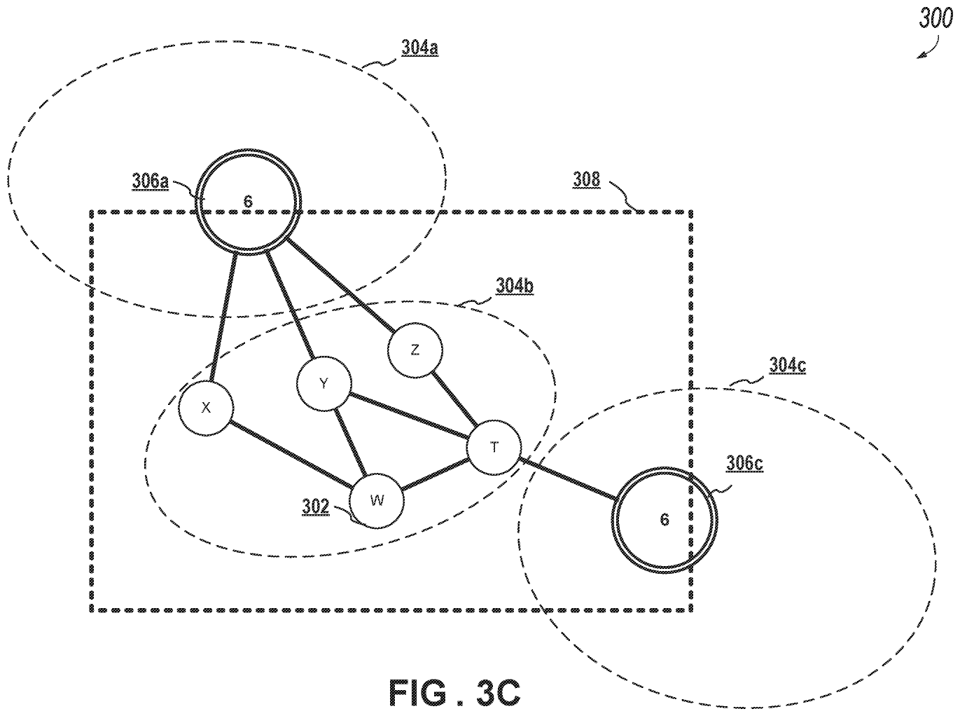

FIGS. 3A-3C illustrate an example network diagram UI 300 that uses pseudo visual elements. FIG. 3A illustrates an entire network diagram that includes a number of nodes 302 with relationships to other nodes as indicated by edges 303, where those nodes form three communities our groups: the vowel group 304a, the consonant group 304b and the numeral group 304c. It should be noted that UI 300 represents a simplified network diagram, and in practice, thousands, tens of thousands, or more nodes can be present in a network diagram.

FIG. 3B illustrates a reduced network diagram for UI 300, where the nodes 302 have been combined into pseudo visual elements 306a-c. Each pseudo visual element 306a-c includes a double line to indicate that the element is a pseudo visual element, and a number label, where the number represents the number of nodes 302 that were combined to form the pseudo visual element.

The pseudo visual elements 306a-c in the illustrated example were selected based on community, which can be determined using a clustering algorithm based on edges or based on parameters associated with the nodes (e.g., vowels or consonants) or other factors. In some implementations nodes 302 are combined into pseudo visual elements 306a-c based on their relative proximity within the UI 300.

A view window 308 is illustrated in FIG. 3B which shows an expected screen space for the client device that UI 300 will be rendered upon. The expected screen space can be determined, for example, based on the connected device, or information embedded in the initial request for the UI300, among other things. In some implementations, pseudo visual elements 306a-c are expanded or exploded into their constituent visual elements 302 in response to a click or tap or other selection. In some instances, as shown in FIG. 3C, if the user zooms in or adjusts the view window 308 to focus on a particular pseudo visual element 306b, then that element can be expanded.

FIG. 3C shows the user has zoomed into the consonant group 304b, as indicated by a reduced size viewing window 308. The zoom can be based on one or more user interactions with their display, including a touch-based or mouse-based input, among others. The previous pseudo visual element 306b from FIG. 3B has expanded back to its constituent nodes 302, showing the details and connections of those individual nodes, while maintaining the rest of the network diagram rendered as pseudo visual elements 306a and 306c.

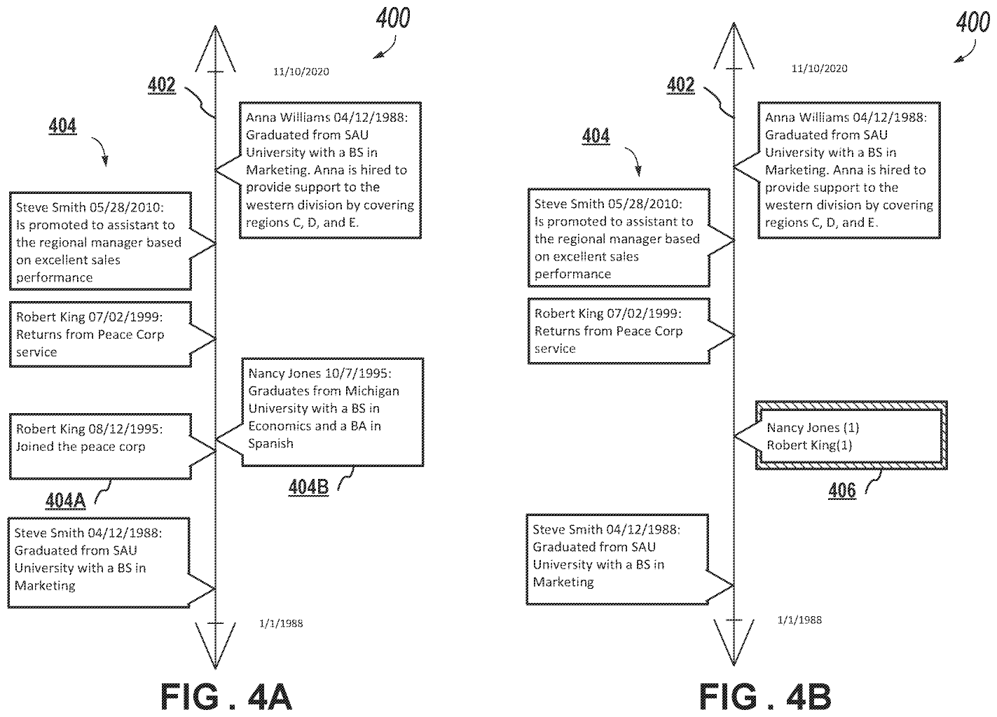

FIGS. 4A and 4B illustrate an example timeline UI that uses pseudo visual elements. The timeline 400 can be rendered on a user device, or a display associated with the user device and includes a number of events 404 arranged chronologically. In the illustrated example the events are personnel management events for a company, but any suitable timeline UI is considered with in the scope of this disclosure.

FIG. 4A shows the full timeline, with all events 404 and associated descriptions present. It should be noted that, while only six events are illustrated, timeline UIs can frequently be much larger, including thousands or tens of thousands or more events. Pseudo visual elements can be used to more efficiently render timeline UI's on user devices.

FIG. 4B illustrates events 404A and 404B having been combined into a pseudo visual element 406 that includes some information from both events 404A and 404B, and as a result, a user device rendering the UI 400 of FIG. 4B need only render five visual elements as opposed to the six in FIG. 4A.

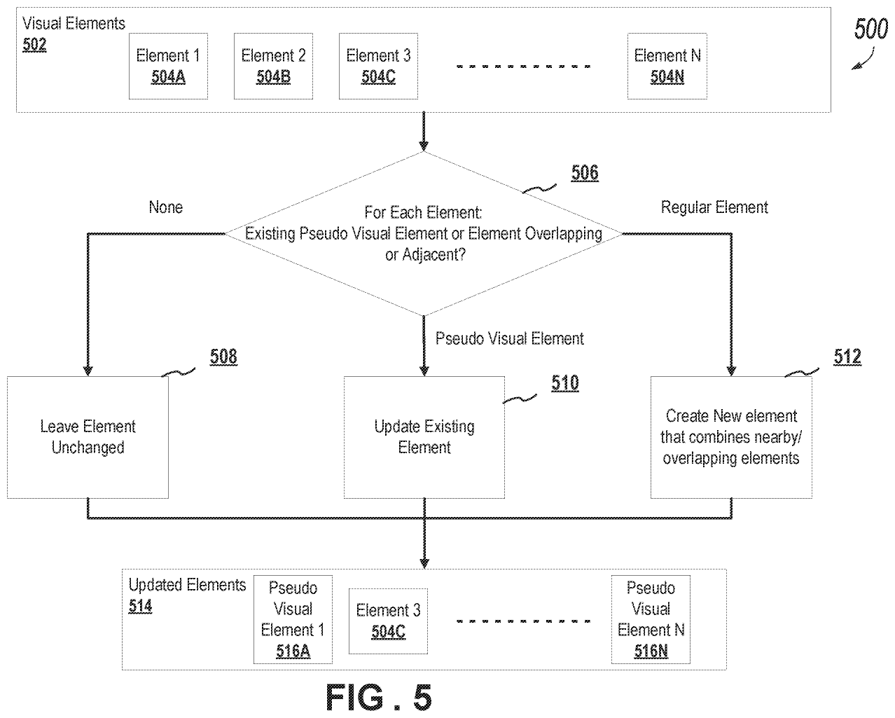

FIG. 5 is a flowchart describing an example process 500 for reducing the number of visual elements in a user interface. It will be understood that process 500 and related methods may be performed, for example, by any suitable system, environment, software, and hardware, or a combination of systems, environments, software, and hardware, as appropriate. For example, a system comprising a communications module, memory storing instructions and other required data, and at least one hardware processor interoperably coupled to the memory and the communications module can be used to execute process 500. In some implementations, the process 500 and related methods are executed by one or more components of the system 100 described above with respect to FIG. 1, such as the backend system 102, and/or portions thereof. Further, it should be noted that process 500 does not necessarily proceed in a sequential manner, and elements of process 500 can happen repeatedly, in parallel, or out of order, as would be understood by one of ordinary skill in the art.

Process 500 can begin with a given UI that includes a group of visual elements 502, where the group of visual elements 502 contains some number of visual elements 504A-504N.

At 506, for each visual element 504A-504N, criteria can be analyzed to determine whether the visual element is to be combined into a pseudo visual element. For example, process 500 can loop through each element in the visual elements 502 and analyze for adjacent elements, overlapping elements (in either time or space), or a pre-existing pseudo visual element associated with adjacent or overlapping elements. In some implementations “adjacent” simply means rendered within a predetermined distance (e.g., number of pixels, percent of screen space, etc.). In some implementations, adjacent means the next element in a sequence (e.g., task 2 is adjacent to task 1, etc.). In implementations where a timeline is used such as in a Gantt chart or a timeline UI, the elements relative time between them can be the criteria for identifying combinable visual elements. For example, elements that overlap, or occur at during the same time period, can be combined into pseudo visual elements. Similarly, elements that are adjacent in time, that is elements that are consecutive, sequential, or form a contiguous series of visual elements can also be combined into pseudo visual elements.

At 508, if there is no nearby, overlapping, or adjacent visual element, that element can remain unchanged, and can be sent directly to a group of updated visual elements 514 (for example, element 3 504C is unchanged between visual elements 502 and updated elements 514).

If an adjacent element is already a pseudo visual element, or a pre-existing pseudo visual element was already created that applies to the current element, then the pre-existing pseudo visual element can be updated at 510 in order to incorporate information for the current element. This updating can include updating label information, changing or adding different colors to the pseudo visual element, or otherwise representing the current element within the pre-existing pseudo visual element.

If an adjacent element is another regular visual element from the visual elements 502, a new pseudo visual element can be generated at 512. The new pseudo visual element can represent, combine, or include the current element and the adjacent element into a single visual element that represents both.

Process 500 can iteratively continue until each element 504A-N in the group of visual elements 502 are analyzed, and a resulting group of updated elements 514 including a combination of pseudo visual elements 516A-N and element(s) (e.g., element 504C) is created. This group of updated elements 514 can then be used to render a UI on a client device, where fewer elements can be rendered as compared to the full groups of visual elements, and computational power is limited.

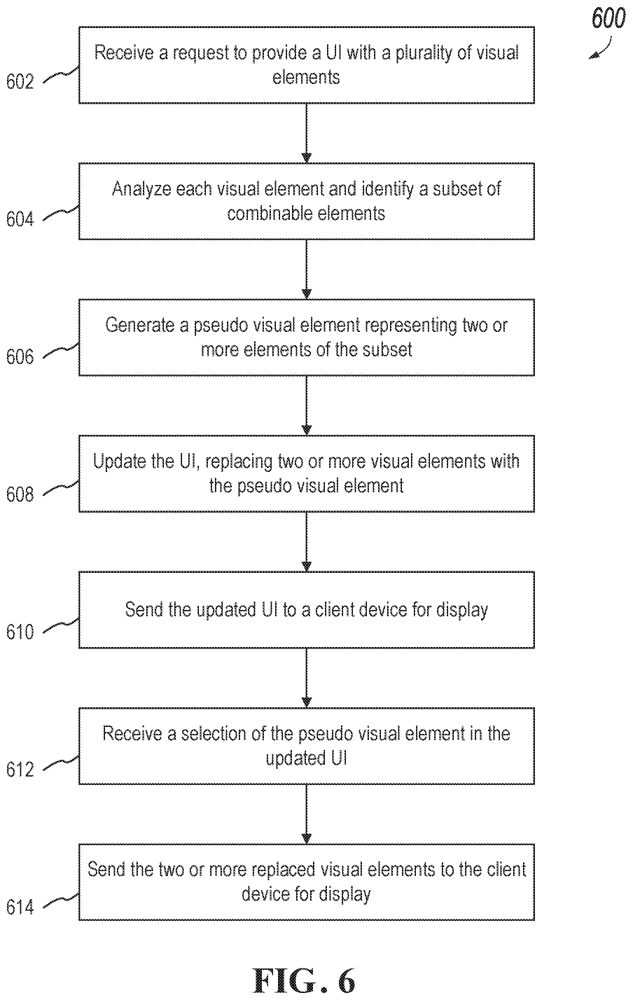

FIG. 6 is a flowchart describing an example process for generating a simplified user interface. It will be understood that process 600 and related methods may be performed, for example, by any suitable system, environment, software, and hardware, or a combination of systems, environments, software, and hardware, as appropriate. For example, a system comprising a communications module, memory storing instructions and other required data, and at least one hardware processor interoperably coupled to the memory and the communications module can be used to execute process 600. In some implementations, the process 600 and related methods are executed by one or more components of the system 100 described above with respect to FIG. 1, such as the backend system 102, client device 122, customer system 114, and/or portions thereof. Further, it should be noted that process 600 does not necessarily proceed in a sequential manner, and elements of process 600 can happen repeatedly, in parallel or out of order as would be understood by one of ordinary skill in the art.

At 602, a request to provide a UI is received at a backend system. The UI includes a plurality of visual elements. The UI can be, for example, a Gantt chart, network graph, process flow, timeline diagram, or other UI. The request can be received from a client device that has limited computing or rendering capacity and can be for a UI of significant complexity. Alternatively, the request can be to deliver the UI at a browser or other application that has limited computing capacity available to it. For example, a browser executing on a personal computer can be limited to single thread processes. Gantt charts, for example, can include visual elements involving tasks, resources, relationships, progress and other parameters rendered against a timeline. Depending on the complexity of the overall project, the Gantt chart can include millions or even billions of visual elements. To render such a chart in a relatively limited context (e.g., a single thread browser executing on a mobile device), the number of visual elements within the chart must be reduced. In some instances, the request includes information about the requesting device including screen space, resolution, compute power, memory, or other parameters.

At 604, each visual element in the UI is analyzed, and a subset of elements that are combinable with other elements is identified. Elements can be combinable where they overlap or are adjacent (e.g., in time) to another nearby element. In some implementations, elements that are combinable are associated with their combinable counterparts. In some implementations, elements that are not combinable are elements that have no nearby neighbors, or that are selected and/or identified for focus, so that no informational detail can be lost or removed during rendering. In some implementations, each combinable element is associated with a start time, stop time, and one or more labels including data (e.g., metadata) regarding the visual element.

At 606, pseudo visual elements are generated representing two or more elements of the subset of visual elements that is combinable. Pseudo visual elements are a single visual element that represents multiple visual elements using graphical techniques. For example, a pseudo visual element can change colors when it is representing two or more overlapping elements. Additionally, the pseudo visual element can have a label that combines the label or data from all of its constituent visual elements.

At 608, the UI is updated by replacing two or more of the combinable visual elements with a pseudo visual element. This results in a UI that has fewer unique visual elements than the original UI but retains much of the visual information.

At 610, the updated UI is sent to the client device for display. The client device can render the updated UI including the pseudo visual element in a display for consumption by the user. In some implementations, the pseudo visual element is selectable, and upon selection, it will expand to render its constituent elements.

At 612, a pseudo visual element in the updated UI is selected. This selection can be received from a user operating the client device and can result in a request sent to a backend system. The backend system can then identify the two or more constituent elements that were replaced with the selected pseudo visual element.

At 614, the two or more replaced visual elements are sent for the client device for display. The client device can render the two or more visual elements in place of the selected pseudo visual element, or in addition to it. For example, in a Gantt chart implementation, the pseudo visual element can remain, with its constituent tasks rendered below it along the time line.

An example implementation of the generation of pseudo visual elements is provided below in Javascript in table 1

```
TABLE 1
  /*
*
      * Creates shape groups for the provided binding information from the context
      * @private
      */
      BasePseudoShape.prototype._findPseudoShapeContextArray =
    function(aContext, oShapePropertyPaths ,oRow, oGantt) {
        var aShapeGroups = [ ], iGroupIndex = 0, iOverlapIndex = 0, oGanttId =
    oGantt.getId( );
        // Verified that operations are sorted in ascending order of their start time.
    If not, we need to sort it that way.
        if (aContext[0]){
          aShapeGroups.push({
            id: oGanttId + “_row-” + oRow.getIndex( ) + “group-” +
    iGroupIndex,
            iShapeCount: 1, //number of overlapping shapes
            startTime:
    aContext[0].getProperty(oShapePropertyPaths.startTime), //start time of pseudo shape
            endTime:
    aContext[0].getProperty(oShapePropertyPaths.endTime), //end time of pseudo shape
            overlaps: [ ], //array of overlap start and end time objects
            aShapeContexts: [aContext[0]], //mostly not needed in
    original implementation, adding so you get all necessary info here
            aShapeIds:
    [aContext[0].getProperty(oShapePropertyPaths.shapeId)]
          });
        }
        for (var i = 1; i < aContext.length; i++) {
          var oOperation = aContext[i];
          //check for complete overlaps
          //incoming shape's start and end time
          var dShapeStartTime =
    oOperation.getProperty(oShapePropertyPaths.startTime),
          dShapeEndTime =
    oOperation.getProperty(oShapePropertyPaths.endTime),
          //Pseudo shape's start and end time
          oShapeGroup = aShapeGroups[iGroupIndex],
          dExistingShapeStartTime = oShapeGroup.startTime,
          dExistingShapeEndTime = oShapeGroup.endTime;
          var dExistingOverlapShapeStartTime =
    oShapeGroup.overlaps[iOverlapIndex] &&
    oShapeGroup.overlaps[iOverlapIndex].startTime,
              dExistingOverlapShapeEndTime =
    oShapeGroup.overlaps[iOverlapIndex] &&
    oShapeGroup.overlaps[iOverlapIndex].endTime;
          //when incoming shape is completely coincided by pseudo shape
          if (dShapeStartTime >= dExistingShapeStartTime &&
    dShapeEndTime <= dExistingShapeEndTime) {
            //fully coinciding do nothing to pseudo shape's start and
    end time
            oShapeGroup.aShapeContexts.push(oOperation);
            oShapeGroup.iShapeCount ++;
      oShapeGroup.aShapeIds.push(oOperation.getProperty(oShapePropertyPaths.sh
    apeId));
            //if overlap are not there yet, add first overlap
            //start time of overlap −> start time of incoming shape,
    end time of overlap −> end time of incoming shape
            if (oShapeGroup.overlaps.length === 0) {
              oShapeGroup.overlaps.push({
                startTime: dShapeStartTime,
                endTime: dShapeEndTime
              });
            } else {
              //if overlap already exists
              //oexisting verlap's start and end time
              //if incoming shape lies withing the existing
    overlap, do nothing
              if (dShapeStartTime >=
    dExistingOverlapShapeStartTime && dShapeEndTime <=
    dExistingOverlapShapeEndTime) {
                //do nothing
              } else if (dShapeStartTime >=
    dExistingOverlapShapeStartTime && dShapeStartTime <
    dExistingOverlapShapeEndTime && dShapeEndTime > dExistingOverlapShapeEndTime)
    {
                //if incoming shape partially coincide with
    the overlap,extend the overlap's end time to the endtime of the incoming shape
      oShapeGroup.overlaps[iOverlapIndex].endTime = dShapeEndTime;
              } else if (dShapeStartTime >
    dExistingOverlapShapeEndTime && dShapeEndTime > dExistingOverlapShapeEndTime)
    {
                //if incoming shape does not coincide
    with the existing overlap at all, create a new overlap object
                oShapeGroup.overlaps.push({
                  startTime: dShapeStartTime,
                  endTime: dShapeEndTime
                });
                iOverlapIndex++;
              }
            }
          } else if (dShapeStartTime >= dExistingShapeStartTime &&
    dShapeStartTime < dExistingShapeEndTime && dShapeEndTime >
    dExistingShapeEndTime) {
            //when incoming shape partially coincides with pseudo
    shape
            oShapeGroup.aShapeContexts.push(oOperation);
            oShapeGroup.iShapeCount++;
      oShapeGroup.aShapeIds.push(oOperation.getProperty(oShapePropertyPaths.sh
    apeId));
            //indicator endtime update
            if (oShapeGroup.overlaps.length === 0) {
              //if overlap are not there yet, add first overlap
              //start time of overlap −> start time of incoming
    shape, end time of overlap −> end time of pseudo shape
              oShapeGroup.overlaps.push({
                startTime: dShapeStartTime,
                endTime: oShapeGroup.endTime
              });
            } else {
              //if overlap already exists
              //existing verlap's start and end time
              if (dShapeStartTime >=
    dExistingOverlapShapeStartTime && dExistingShapeEndTime <=
    dExistingOverlapShapeEndTime) {
                //if incoming shape lies withing the
    existing overlap, do nothing
                //do nothing
              } else if (dShapeStartTime >=
    dExistingOverlapShapeStartTime && dShapeStartTime <
    dExistingOverlapShapeEndTime && dExistingShapeEndTime >
    dExistingOverlapShapeEndTime) {
                //if incoming shape partially coincides
    with the overlap
                // if incoming shape starts before overlap
    ends and the pseudo shape end's after overlap (the new overlap will be till end of pseudo
    shape)
                // then make the existing overlap's end
    time as the pseudo shape's end time
      oShapeGroup.overlaps[iOverlapIndex].endTime = oShapeGroup.endTime;
              } else if (dShapeStartTime >
    dExistingOverlapShapeEndTime && dExistingShapeEndTime >
    dExistingOverlapShapeEndTime) {
                // for new overlaps, add the
    corresponding object
                oShapeGroup.overlaps.push({
                  startTime: dShapeStartTime,
                  endTime:
    oShapeGroup.endTime
                });
                iOverlapIndex++;
              }
            }
            //update pseudo shape's end time as the incoming
    shape's end time
            oShapeGroup.endTime = dShapeEndTime;
          } else if (dShapeStartTime >= dExistingShapeEndTime &&
    dShapeEndTime >= dExistingShapeEndTime) {
            //for new pseudo shape, add corresponding object
            iGroupIndex++;
            iOverlapIndex = 0;
            aShapeGroups.push({
              id: oGanttId + “_row-” + oRow.getIndex( ) +
    “group-” + iGroupIndex,
              iShapeCount: 1,
              startTime: dShapeStartTime,
              endTime: dShapeEndTime,
              overlaps: [ ],
              aShapeContexts: [oOperation],
              aShapeIds:
    [oOperation.getProperty(oShapePropertyPaths.shapeId)]
            });
          }
        }
        return aShapeGroups;
      };
```

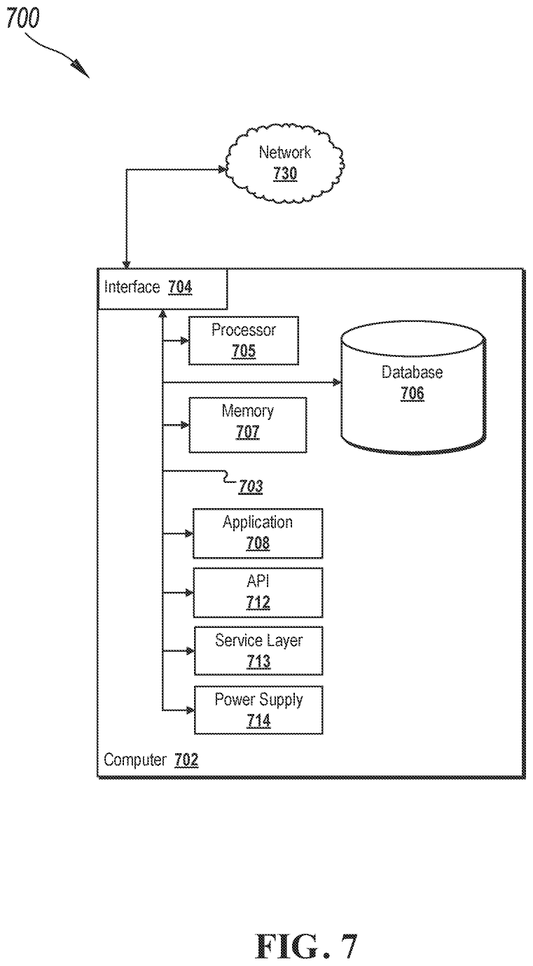

FIG. 7 is a block diagram illustrating an example of a computer-implemented system 700 used to provide computational functionalities associated with described algorithms, methods, functions, processes, flows, and procedures, according to an implementation of the present disclosure. In the illustrated implementation, system 700 includes a computer 702 and a network 730.

The illustrated computer 702 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 702 can include an input device, such as a keypad, keyboard, or touch screen, or a combination of input devices that can accept user information, and an output device that conveys information associated with the operation of the computer 702, including digital data, visual, audio, another type of information, or a combination of types of information, on a graphical-type user interface (UI) (or GUI) or other UI.

The computer 702 can serve in a role in a distributed computing system as, for example, a client, network component, a server, or a database or another persistency, or a combination of roles for performing the subject matter described in the present disclosure. The illustrated computer 702 is communicably coupled with a network 730. In some implementations, one or more components of the computer 702 can be configured to operate within an environment, or a combination of environments, including cloud-computing, local, or global.

At a high level, the computer 702 is an electronic computing device operable to receive, transmit, process, store, or manage data and information associated with the described subject matter. According to some implementations, the computer 702 can also include or be communicably coupled with a server, such as an application server, e-mail server, web server, caching server, or streaming data server, or a combination of servers.

The computer 702 can receive requests over network 730 (for example, from a client software application executing on another computer 702) and respond to the received requests by processing the received requests using a software application or a combination of software applications. In addition, requests can also be sent to the computer 702 from internal users (for example, from a command console or by another internal access method), external or third-parties, or other entities, individuals, systems, or computers.

Each of the components of the computer 702 can communicate using a system bus 703. In some implementations, any or all of the components of the computer 702, including hardware, software, or a combination of hardware and software, can interface over the system bus 703 using an application programming interface (API) 712, a service layer 713, or a combination of the API 712 and service layer 713. The API 712 can include specifications for routines, data structures, and object classes. The API 712 can be either computer-language independent or dependent and refer to a complete interface, a single function, or even a set of APIs. The service layer 713 provides software services to the computer 702 or other components (whether illustrated or not) that are communicably coupled to the computer 702. The functionality of the computer 702 can be accessible for all service consumers using the service layer 713. Software services, such as those provided by the service layer 713, provide reusable, defined functionalities through a defined interface. For example, the interface can be software written in a computing language (for example, JAVA or C++) or a combination of computing languages and providing data in a particular format (for example, extensible markup language (XML)) or a combination of formats. While illustrated as an integrated component of the computer 702, alternative implementations can illustrate the API 712 or the service layer 713 as stand-alone components in relation to other components of the computer 702 or other components (whether illustrated or not) that are communicably coupled to the computer 702. Moreover, any or all parts of the API 712 or the service layer 713 can be implemented as a child or a sub-module of another software module, enterprise application, or hardware module without departing from the scope of the present disclosure.

The computer 702 includes an interface 704. Although illustrated as a single interface 704, two or more interfaces 704 can be used according to particular needs, desires, or particular implementations of the computer 702. The interface 704 is used by the computer 702 for communicating with another computing system (whether illustrated or not) that is communicatively linked to the network 730 in a distributed environment. Generally, the interface 704 is operable to communicate with the network 730 and includes logic encoded in software, hardware, or a combination of software and hardware. More specifically, the interface 704 can include software supporting one or more communication protocols associated with communications such that the network 730 or hardware of interface 704 is operable to communicate physical signals within and outside of the illustrated computer 702.

The computer 702 includes a processor 705. Although illustrated as a single processor 705, two or more processors 705 can be used according to particular needs, desires, or particular implementations of the computer 702. Generally, the processor 705 executes instructions and manipulates data to perform the operations of the computer 702 and any algorithms, methods, functions, processes, flows, and procedures as described in the present disclosure.

The computer 702 also includes a database 706 that can hold data for the computer 702, another component communicatively linked to the network 730 (whether illustrated or not), or a combination of the computer 702 and another component. For example, database 706 can be an in-memory or conventional database storing data consistent with the present disclosure. In some implementations, database 706 can be a combination of two or more different database types (for example, a hybrid in-memory and conventional database) according to particular needs, desires, or particular implementations of the computer 702 and the described functionality. Although illustrated as a single database 706, two or more databases of similar or differing types can be used according to particular needs, desires, or particular implementations of the computer 702 and the described functionality. While database 706 is illustrated as an integral component of the computer 702, in alternative implementations, database 706 can be external to the computer 702. The database 706 can hold any data type necessary for the described solution.

The computer 702 also includes a memory 707 that can hold data for the computer 702, another component or components communicatively linked to the network 730 (whether illustrated or not), or a combination of the computer 702 and another component. Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707, two or more memories 707 or similar or differing types can be used according to particular needs, desires, or particular implementations of the computer 702 and the described functionality. While memory 707 is illustrated as an integral component of the computer 702, in alternative implementations, memory 707 can be external to the computer 702.

The application 708 is an algorithmic software engine providing functionality according to particular needs, desires, or particular implementations of the computer 702, particularly with respect to functionality described in the present disclosure. For example, application 708 can serve as one or more components, modules, or applications. Further, although illustrated as a single application 708, the application 708 can be implemented as multiple applications 708 on the computer 702. In addition, although illustrated as integral to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion or management circuits (including recharging, standby, or another power management functionality). In some implementations, the power supply 714 can include a power plug to allow the computer 702 to be plugged into a wall socket or another power source to, for example, power the computer 702 or recharge a rechargeable battery.

There can be any number of computers 702 associated with, or external to, a computer system containing computer 702, each computer 702 communicating over network 730. Further, the term “client,” “user,” or other appropriate terminology can be used interchangeably, as appropriate, without departing from the scope of the present disclosure. Moreover, the present disclosure contemplates that many users can use one computer 702, or that one user can use multiple computers 702.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method comprising:
receiving a request to provide a user interface comprising a plurality of visual elements;
analyzing the plurality of visual elements to identify a subset of visual elements that are combinable;
based on the analysis, generating a pseudo visual element, wherein the pseudo visual element represents two or more particular visual elements of the subset of visual elements, wherein each particular visual element is graphically represented in the pseudo visual element;
updating the user interface by replacing the two or more particular visual elements with the pseudo visual element; and
sending information to a client device to cause the client device to render the updated user interface at a display associated with the client device.

2. The method of claim 1, wherein the subset of visual elements that are combinable comprises visual elements that are at least one of: adjacent to each other; or within a predetermined distance from each other.

3. The method of claim 2, wherein the predetermined distance or adjacency is based on the relative location of the subset of visual elements on a timeline.

4. The method of claim 1, wherein the subset of visual elements that are combinable comprises visual elements that are associated with overlapping timelines.

5. The method of claim 1, wherein the pseudo visual element comprises multiple colors, and where the multiple colors graphically represent each particular visual element.

6. The method of claim 1, comprising:
receiving a selection of the pseudo visual element in the updated user interface; and
in response to receiving the selection,
sending information to the client device to cause the two or more replaced visual elements to be rendered in the updated user interface.

7. The method of claim 6, wherein the pseudo visual element is rendered next to the two or more replaced visual elements.

8. The method of claim 1, wherein the user interface is a Gantt chart, and wherein the visual elements are tasks to be rendered within a timeline of the Gantt chart.

9. The method of claim 1, wherein the user interface is a network diagram comprising nodes and edges, and wherein the visual elements are nodes within the network diagram.

10. A non-transitory, computer-readable medium storing one or more instructions executable by a computer system to perform operations comprising:
receiving a request to provide a user interface comprising a plurality of visual elements;
analyzing the plurality of visual elements to identify a subset of visual elements that are combinable;
based on the analysis, generating a pseudo visual element, wherein the pseudo visual element represents two or more particular visual elements of the subset of visual elements, wherein each particular visual element is graphically represented in the pseudo visual element;
updating the user interface by replacing the two or more particular visual elements with the pseudo visual element; and
sending information to a client device to cause the client device to render the updated user interface at a display associated with the client device.

11. The medium of claim 10, wherein the subset of visual elements that are combinable comprises visual elements that are at least one of: adjacent to each other; or within a predetermined distance from each other.

12. The medium of claim 10, wherein the subset of visual elements that are combinable comprises visual elements that are associated with overlapping timelines.

13. The medium of claim 10, wherein the pseudo visual element comprises multiple colors, and where the multiple colors graphically represent each particular visual element.

14. The medium of claim 10, comprising:
receiving a selection of the pseudo visual element in the updated user interface; and
in response to receiving the selection,
sending information to the client device to cause the two or more replaced visual elements to be rendered in the updated user interface.

15. The medium of claim 14, wherein the pseudo visual element is removed from the user interface in response to the selection.

16. The medium of claim 14, wherein the pseudo visual element is rendered next to the two or more replaced visual elements.

17. The medium of claim 10, wherein the user interface is a Gantt chart, and wherein the visual elements are tasks to be rendered within a timeline of the Gantt chart.

18. The medium of claim 10, wherein the user interface is a network diagram comprising nodes and edges, and wherein the visual elements are nodes within the network diagram.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a request to provide a user interface comprising a plurality of visual elements;
analyzing the plurality of visual elements to identify a subset of visual elements that are combinable;
based on the analysis, generating a pseudo visual element, wherein the pseudo visual element represents two or more particular visual elements of the subset of visual elements, wherein each particular visual element is graphically represented in the pseudo visual element;
updating the user interface by replacing the two or more particular visual elements with the pseudo visual element; and
sending information to a client device to cause the client device to render the updated user interface at a display associated with the client device.

20. The system of claim 19, wherein the subset of visual elements that are combinable comprises visual elements that are at least one of: adjacent to each other; or within a predetermined distance from each other.
